(19) United States
(12) Patent Application Publication
(10) Pub. No.: US 2010/0140974 A1
(43) Pub. Date: Jun. 10, 2010

(54) EMERGENCY FOLDING TOP

(75) Inventors: Ulf Plettrichs, Dillishausen (DE); Stefan Kaiser, Augsburg (DE); Stephan Talermann, Munchen (DE); Nazar Kosylo, Planegg (DE)

Correspondence Address: Setter Roche LLP, P.O. Box 780, Erie, CO, 80516, US

(73) Assignee: HS GENION GMBH, Krailling (DE)

(21) Appl. No.: 12/526,218

(22) PCT Filed: Feb. 7, 2007
(86) PCT No.: PCT/DE08/00208

§ 371 Date: Jan. 26, 2010

(30) Foreign Application Priority Data
Feb. 8, 2007 (DE) 10 2007 006 382.4

(51) Int. Cl. B60J 7/00

(52) U.S. Cl. 296/107.09

(57) ABSTRACT

The invention relates to an emergency folding top for a roof opening in a vehicle. Said folding top comprises at least one folding canopy (3) and a rod mechanism (2) for unfolding and folding the canopy (3). The rod mechanism (2) is designed like an umbrella mechanism while the canopy (3) can be moved from a state in which the same is folded like a rope into a state in which the same is stretched in a planar manner.

### FIELD OF THE INVENTION

The invention relates to an emergency folding top.

### BACKGROUND OF THE INVENTION

Emergency tops for motor vehicles are known. In particular, vehicles with removable hard-top elements, e.g. roof shell elements, are reliant on an emergency top being provided, for example, if the driver decides to begin a journey with an open top, and if there is no possibility of taking along the removable rigid roof element (Targa-roof) because of the room available in the vehicle body. If the driver now drives into bad weather including precipitation, an option for at least provisionally closing the roof aperture and preventing precipitation from entering has to be provided. Known emergency tops are configured, for example, as roof tarpaulins that can be buttoned on or off, which are taken out of a storage compartment if needed, are unfolded, and attached to the vehicle body by means of press studs so as to span the roof opening. Furthermore, inflatable emergency tops are known. The drawbacks are that, either, assembly by buttoning is complicated, or that inflating the emergency top requires a corresponding unit. Another disadvantage is that, in the case of emergency tops fastened with buttons, the buttoning areas oftentimes are not very attractive since they often remain visible. The result is thus that assembly requires a lot of effort. The appearance of known emergency top is not always attractive. A greater amount of space as well as, possibly, one or more additional units are required.

A linking mechanism for an umbrella comprising telescopic roof rods is known from BE 498015. In addition, each telescopic roof rod is allocated a first push rod connected with an actuating element in an articulated manner. The push rod is connected to the roof rod member which is firmly attached to the articulation point of the roof rod members. After collapsing the umbrella, this construction makes it possible to compress the umbrella, which is folded in a rope-like manner, lengthwise and thus to reduce the pack size in the longitudinal direction. Such a linking mechanism has proven valuable in umbrellas.

An actuating mechanism (linking mechanism) for an umbrella comprising telescopic roof rods and corresponding first push rods is also known from WO 2005/048765 A1. The first push rods are respectively connected in an articulated manner with an outer roof rod member which is mounted displaceably relative to an inner roof rod member. This linking system has also proven valuable in umbrellas.

A collapsible umbrella comprising roof rods that can be shortened in three ways is known from the German utility model G 8803967.6, wherein the roof rods are divided into roof rod sections respectively interconnected via complicated joint and guidance mechanisms. Such a linking system has proven valuable in umbrellas, but it is totally unsuitable for use in an emergency folding top because the linking mechanism is very complicated and complex, and furthermore does not withstand the large forces acting on an emergency folding top in operation (airstream up to more than 200 km/h).

It is therefore an object of the invention to specify an emergency folding top for vehicles which can easily be unfolded and collapsed again.

It is another object of the invention to specify an emergency folding top which requires as little space as possible both in the opened and in the collapsed state. Furthermore, the emergency folding top is supposed to be suitable to be able to reliably withstand the forces arising during the operation of such an emergency top.

It is another object of the invention to specify an emergency folding top for vehicles, the linking mechanism of which requires only little constructional space during operation, so that, in the opened state, the interior of a passenger compartment is affected as little as possible.

Moreover, it is to be avoided that the points or devices of attachment for an emergency folding top remain invisible, if possible.

It is another object of the invention to keep the actuation forces for unfolding and collapsing the emergency top as small as possible.

### SUMMARY OF THE INVENTION

It was recognized, according to the invention, that an umbrella-type linking mechanism is also suitable for forming an emergency folding top for motor vehicles, particularly, however, in the case where a staff is dispensed with. In this case, it is advantageous that the emergency folding top in the collapsed state has an umbrella-type rope-like three-dimensional shape and is thus easily stowed away. It is another advantage that an umbrella-type linking mechanism comprises roof rods on whose ends fasteners can easily be provided, which correspond with the fasteners of a solid roof part of a vehicle on the body. Additional fixing points for the emergency folding top can thereby be avoided. Moreover, it is advantageous that, in an umbrella-type linking mechanism, a roof curvature of a folding-top tarpaulin can easily be realized and that, thus, the appearance of the rigid roof part of a vehicle can be reproduced well by means of the emergency folding top.

In one embodiment, it is particularly advantageous that, on the one hand, an emergency folding top according to the invention, which requires few individual parts and can thus be produced easily, can be realized due to the linking mechanism chosen. Moreover, it is advantageous that, by providing a locking device between a first articulation point and a second articulation point, the emergency folding top can be locked in a defined manner in an opened arrangement using, in particular, a mechanical connection of the two articulation points. This measure offers the option of being able to dispense with the staff usually provided in umbrella assemblies, on which the second articulation point, where the push rods are articulated, slides, or that the staff is at least removable, i.e. configured to be mechanically detachable from the first articulation point, so that, in the opened state of the emergency folding top, there is no staff which affects the interior of the vehicle, but that, together with the actuation/linking mechanism, the folding-top tarpaulin alone forms the emergency folding top.

Another option for configuring such an emergency folding top without an actuating staff or with a detachably connected actuating staff, in the way of a “self-supporting” emergency folding top, is specified in another embodiment, wherein either first or second push rods, in the opened arrangement of the emergency top, assume a kinematic over-dead-point arrangement, so that the first articulation point of the roof rods and the second articulation point of the roof rods are pressed against each other due to the resultant forces in the opened arrangement of the emergency top. In this case, a locking device may optionally be dispensed with, because the linking mechanism is configured to be self-locking. Of course, an additional locking device may be provided by way of support for this self-locking action. In the case of this arrangement, it is also possible to dispense with the staff as it is usually provided in umbrellas, or to configure it to be detachable and removable, so that there is no negative effect on the interior of a passenger compartment.

Nevertheless, a staff, along which the second articulation point is displaceably mounted, may expediently be provided at least for opening the emergency folding top. For ergonomic or handling reasons, this may be useful in particular for opening.

Another embodiment, according to which the staff can removably, i.e. detachably, released from the linking mechanism at least after the emergency folding top has been opened, is also expedient in this case.

Yet another advantageous embodiment has a linking mechanism with telescopic roof rods, whereby a particularly small three-dimensional shape of the emergency folding top in the collapsed state can be realized. This is done successfully particularly by a first push rod being on one end connected with a corresponding outer second roof rod member which is mounted so as to be telescopically displaceable relative to a first inner roof rod member.

Though an alternative embodiment provides a staff, this can be swung out of the interior of the passenger compartment, after the emergency folding top is opened, by means of a joint which in the opened state is preferably disposed directly underneath the second articulation point.

Moreover, it is advantageous to provide actuation force transmission devices for opening and relaxing the emergency top, so that the actuation forces remain small during opening and, in the case of the linking mechanism being configured in the way of an over-dead-point linking system, also when the emergency top is collapsed. Actuation force transmission devices that, for example, use a spindle nut in a spindle-like manner or a toggle lever or an eccentric have proven suitable. A force transmission ratio of, for example, 2:1 or more has proven suitable as a force transmission ratio, i.e., the actuation force to be exerted by the operator is only half as large or less compared with the required actuation force of the linking mechanism.

In addition or alternatively, a motor-operated drive system for opening or collapsing the emergency folding top again may be provided.

In order to realize the above-mentioned over-dead-point position, it is expedient, for example, to select a distance d in a vertical direction between the joints of the roof rods and those of the second push rods at the first articulation point, such that the second push rods, in the opened arrangement, assume an angle α>90° relative to a vertical direction, i.e. in particular relative to an actuation direction of the second articulation point relative to the first articulation point. A self-locking over-dead-point position is thereby realized.

Alternatively, there is the option of configuring a distance d in a vertical direction between the joints of the roof rods and those of the first push rods at the second articulation point in the opened state, such that the first push rods assume an angle β>90° relative to an actuation direction in the opened state. This also ensures a self-locking action of the linking system because of an over-dead-point arrangement.

By way of example, an embodiment of the emergency top according to the invention will be explained below with reference to the drawings.

### BRIEF DESCRIPTION OF THE DRAWINGS

In the figures:

FIG. 1 schematically shows a linking mechanism of an emergency folding top according to one embodiment of the invention in a collapsed arrangement.

FIG. 2 shows a partial side view of the linking mechanism of FIG. 1 in a partially opened arrangement.

FIG. 3 shows an isometric view of the linking mechanism according to FIG. 1 in a partially opened arrangement.

FIG. 4 schematically shows an embodiment of the linking mechanism for the emergency folding top according to one embodiment of the invention with a locking device and without a staff.

FIG. 5 shows another embodiment of a linking mechanism for the emergency folding top according to one embodiment of the invention in a self-locking over-dead-point arrangement.

### DETAILED DESCRIPTION OF THE PREFERRED EMBODIMENTS

An emergency folding top 1 (FIGS. 1 to 5) according to the invention comprises an umbrella-type and/or parasol-type linking mechanism 2 with which a folding-top tarpaulin 3 can be collapsed and opened. The linking mechanism 2 comprises a plurality of roof rods 4 with which the folding-top tarpaulin 3 is coupled and by means of which it can be collapsed and opened. The roof rods 4 are respectively articulated on one end with a joint 5 to a first articulation point 6. A fastener 8 is respectively provided on the opposite side, on the free end 7 of the roof rods 4, by means of which the emergency folding top 1 can be fastened to corresponding fasteners of a hard-top roof part on a vehicle body. The roof rods 4 are configured as telescopic rods with an inner roof rod member 9 and an outer roof rod member 10, with the outer roof rod member 10, relative to the inner roof rod member 9, being disposed to be telescopically displaceable on the latter. The inner roof rod member 9 and the outer roof rod member 10 can be extended or shortened along a displacement direction 11a. A first push rod 12 is pivotably connected with a joint 13 in the area of an inner end 11 of the outer roof rod 10. The push rod 12 extends from the inner end 11 of the outer roof rod member 10 to a second articulation point 14 and is also pivotably mounted relative to it by means of a joint 15. A second push rod 16 is connected to the first push rod 12 by means of a joint 17 in an area between the joints 13 and 15 of the first push rod 12. The second push rod 16 extends from the joint 17 to the first articulation point 6 and is pivotably connected by means of a joint 18 with the first articulation point 6 at a distance d₁ from the joint 5 of the inner roof rod member 9.

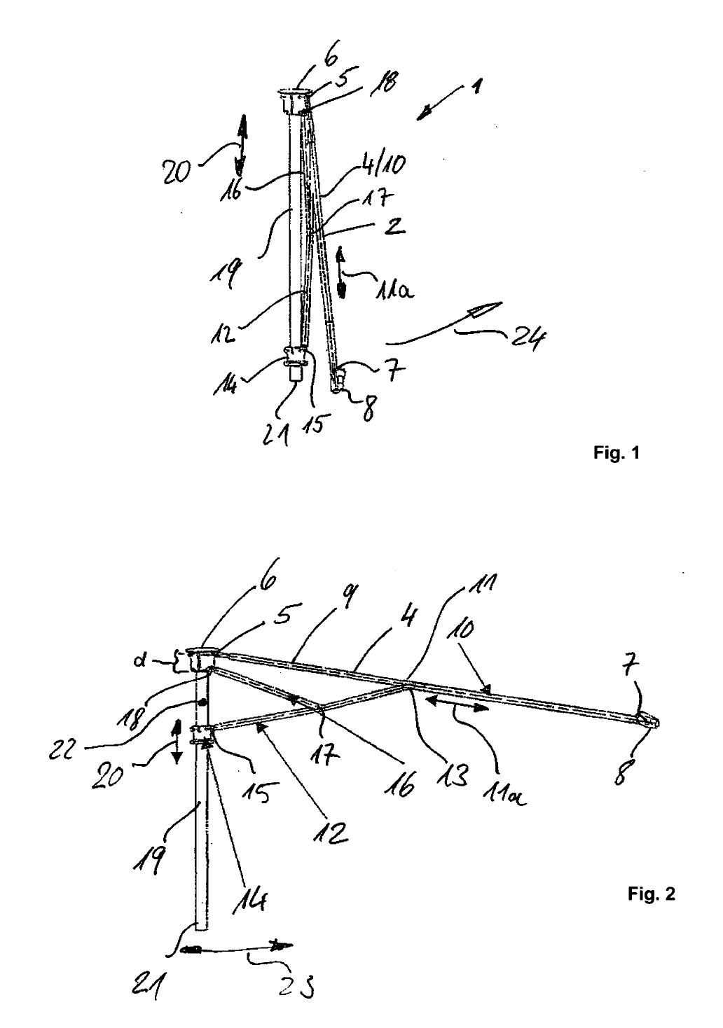

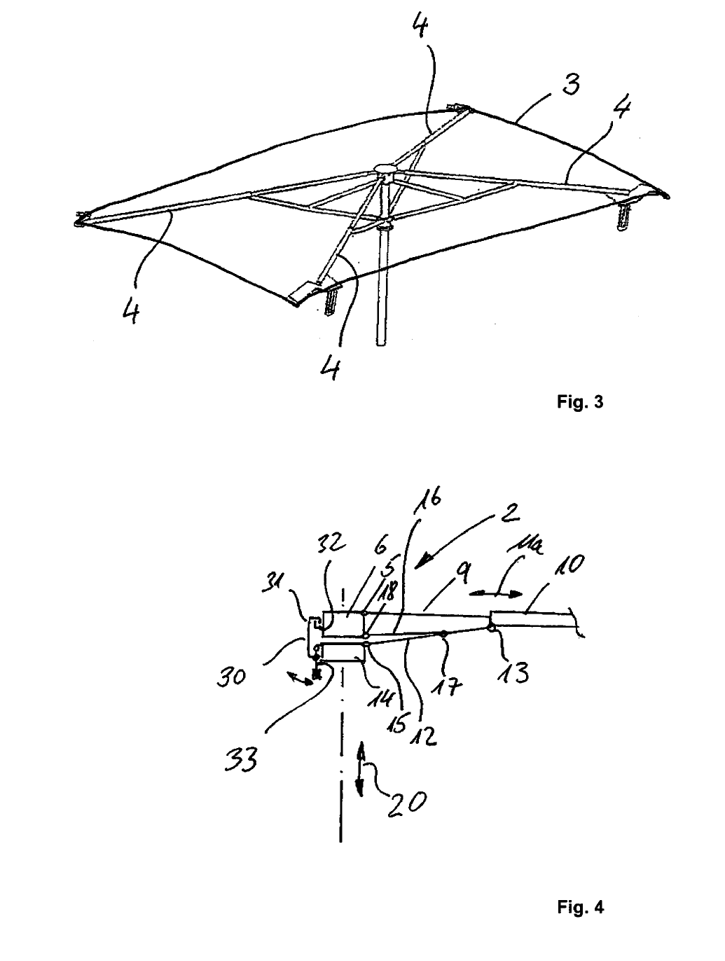

The previously described guidance arrangement explained with reference to FIGS. 1 and 2, as is particularly apparent from FIG. 3, is provided multiple times in a corresponding manner in order to support the folding-top tarpaulin 3 in a planar, openable and collapsible way. A total of four guidance arrangements according to FIG. 2 are provided in the exemplary embodiment according to FIG. 3.

In the embodiment according to FIGS. 1 to 3, a staff 19 is additionally provided which on one end is attached in the first articulation point 6 and on which the second articulation point 14 is mounted displaceably in an actuation direction 20 (direction of the double arrow). The staff 19 has a free end 21. Preferably, the staff 19 is detachably attached in the first articulation point.

As an alternative to the detachable attachment in the first articulation point 6, the staff 19 may also comprise a joint 22, so that the staff 19, in an opened arrangement of the emergency folding top 1, can be swung away directly underneath the second articulation point, for example in a direction along the direction of the double arrow 23.

The initial state of the emergency folding top and the opening of the emergency folding top is briefly described below with reference to the FIGS. 1 to 3.

In an initial state (collapsed state) of the emergency folding top 1 according to the invention, the roof rods 4, the first push rods 12 and the second push rods 16 are disposed parallel or almost parallel to the actuation direction 20, in particular disposed adjacent to the staff 19, so that in this collapsed state, the emergency folding top 1 has an almost rope-like three-dimensional shape. In this position, the second articulation point 14 is disposed with a maximum distance from the first articulation point 6, for example in the area of the free end 21 of the staff 19, if provided.

In order to open the emergency folding top, the second articulation point 14 is moved towards the first articulation point 6 in the actuation direction 20. The roof rods 4 are thereby moved in a swing-open direction 24 via the first push rods 12. In the process, the roof rods 4 are extended in a telescope-like manner.

In a partially opened position in accordance with FIG. 2, the second articulation point 14 is moved almost completely towards the first articulation point 6. Preferably, the kinematics of the linking mechanism 2 are designed such that the articulation points 6 and 14 adjoin each other in the completely opened state. In this position, the optionally provided staff 19 can then readily be swung away about the joint 22, and thus, swung out of the interior area of a passenger compartment, in particular towards the folding-top tarpaulin 3. In this opened state, the emergency folding top can be inserted into an existing roof aperture of a vehicle and connected with the body by means of the fasteners 8. If the staff 19 is detachably disposed in the first articulation point 6, it can alternatively also be removed and thus also does not have a negative effect on the interior or the size of the interior of the passenger compartment, respectively.

Moreover, another embodiment of the emergency folding top 1 according to the invention comprises on its linking mechanism 2 a locking device 30 with which the first articulation point 6 and the second articulation point 14 can be locked with each other in the opened state, for example in accordance with FIG. 4.

The locking device 30 has, for example, a locking hook 31 which cooperates with a counter-locking hook 32 on the first articulation point 6. The locking hook 31 is connected in a known manner with an actuating lever 33 articulated to the second articulation point 14. The kinematics of this locking device 30 are designed in the way of an over-dead-point kinematic system, so that the locking device 30 is configured to be self-locking when the locking lever 33 is actuated. This ensures that, in the opened state, the articulation points 6, 14 are firmly interconnected and that thus, a safe opening of the emergency folding top 1 is ensured.

Furthermore, the emergency folding top 1 is shown schematically and sectionally in FIG. 4, with the staff 19 being removed. Furthermore, it is of course possible, if the roof rods 4, the first and second push rods 12, 16, and the articulation points 6, 14 are designed with suitable rigidity, to dispense completely with the staff 19, because a reliable guidance of the second articulation point 14 relative to the first articulation point 6 is possible in a kinematically defined manner by means of the roof rods 4, the first push rods 12 and the second push rods 16.

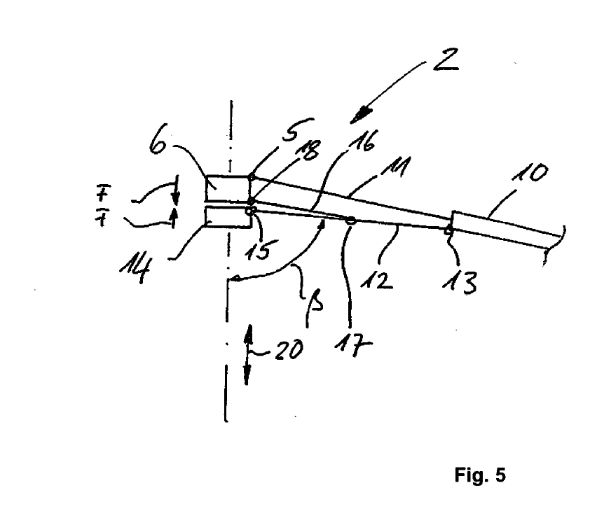

According to another embodiment of the linking mechanism 2 of the emergency folding top 1 according to the invention, the guidance arrangement of the roof rods 4, the first push rods 12 and the second push rods 16 is chosen such that in the opened state according to FIG. 5, at least the first push rods 12 or the second push rods 16 lie in a so-called over-dead-point arrangement relative to each other, so that resultant forces F occur in relation to the articulation points 6 and 14, which urge them towards each other. The resultant forces are generated by the opened folding-top tarpaulin 3. In such an over-dead-point position, the first push rod 12, for example, encloses an angle β with an actuation direction 20, with the angle being β<90° (compare FIG. 5). A force component pushing the articulation point 14 towards the articulation point 6 remains in such an arrangement. A self-locking action is thus accomplished in the opened arrangement of the emergency folding top 1 according to the invention, which can render unnecessary the provision of locking devices 30, because the emergency folding top 1 automatically remains in the opened unfurled state.

An emergency folding top according to the invention thus configured ensures a simple operation and requires only little space both in the collapsed and in the opened state. An approximation of the curvature of the folding-top tarpaulin to a predetermined outer contour of the body is thus also possible in a simple manner.

1. An emergency folding top for a roof aperture of a vehicle, comprising:
at least one foldable folding-top tarpaulin and a linking mechanism for unfolding and collapsing the folding-top tarpaulin, wherein the linking mechanism is configured in the manner of an umbrella mechanism, and the folding-top tarpaulin can be brought from a rope-like collapsed state into an opened state spread in a planar manner.

2. The emergency folding top according to claim 1, wherein the linking mechanism comprises:
a plurality of roof rods respectively articulated to a first articulation point, wherein the folding-top tarpaulin can be opened and collapsed using the roof rods;
a number of first push rods corresponding to the number of roof rods, wherein each of the first push rods is respectively articulated on one end to a roof rod and on an opposite end articulated to a second articulation point; and
a number of second push rods, each of which is articulated on one end to the first articulation point in an actuation direction with a distance (d) from the respective roof rods and, on an opposite end, is articulated to the respectively corresponding first push rod.

3. The emergency folding top according to claim 2,
wherein the first or second push rods, in an opened arrangement of the emergency top, are disposed in a kinematic over-dead-point arrangement, so that the second articulation point and the first articulation point, in the opened state, are pressed against each other due to the resultant forces.

4. The emergency folding top according to claim 2, wherein the linking mechanism further comprises a staff on which the second articulation point is displaceably mounted.

5. The emergency folding top according to claim 4, wherein the staff is detachably connected to the first articulation point.

6. The emergency folding top according to claim 2, wherein the roof rods are formed from at least a first inner roof rod member and at least a second outer roof rod member so as to be telescopic.

7. The emergency folding top according to claim 6, wherein the first push rods are connected on one end with the corresponding second outer roof rod member.

8. The emergency folding top according to claim 7, wherein the second outer roof rod member is displaceably mounted on the first roof rod member and encloses it.

9. The emergency folding top according to one of the preceding claims claim 4, wherein the staff comprises a joint which in the opened state is disposed directly underneath the second articulation point.

10. The emergency folding top according to claim 2, wherein the linking mechanism further comprises fasteners on free ends of the roof rods, and the fasteners cooperate and/or correspond with counter-fasteners of a roof part of a vehicle body.

11. The emergency folding top according to claim 1, further comprising at least one actuation force transmission device for opening and relaxing the emergency top.

12. The emergency folding top according to claim 11, wherein the at least one actuation force transmission device comprises a spindle with a spindle nut, a toggle lever or an eccentric.

13. The emergency folding top according to claim 2, wherein the second articulation point can be driven along its actuation direction using a motor.

14. The emergency folding top according to claim 1, wherein the emergency top does not comprise a staff.

15. The emergency folding top according to claim 2, wherein the distance in the actuation direction between the joints of the roof rods and those of the first push rods at the first articulation point is selected such that, in the opened state, the first push rods have an angle β<90° relative to a vertical direction.

16. The emergency folding top according to claim 2, wherein the linking mechanism further comprises a locking and/or connecting device for connecting or locking the first articulation point and the second articulation point.
